(19) United States
(12) Patent Application Publication
(10) Pub. No.: US 2012/0014127 A1
(43) Pub. Date: Jan. 19, 2012

(54) Linear Light Source with Enhanced Light Extraction

(75) Inventors: Udayan Kanade, Pune (IN); Dimple Kuriakose, Pune (IN); Ruby Rama Praveen, Pune (IN); Sanat Ganu, Pune (IN)

(73) Assignee: I2IC Corporation, Foster City, CA (US)

(21) Appl. No.: 13/259,302

(22) PCT Filed: Mar. 23, 2010
(86) PCT No.: PCT/US2010/028372

§ 371 Date: Sep. 23, 2011

(30) Foreign Application Priority Data
Mar. 23, 2009 (IN) 669/MUM/2009
Aug. 24, 2009 (IN) 1942/MUM/2009

(51) Int. Cl. F21V 13/04

(52) U.S. Cl. 362/558

(57) ABSTRACT

Linear light sources with features that enhance light extraction are disclosed. In an embodiment, a linear light guide with one or more reflective faces is oriented in such a manner that deflected light undergoes reduced reflections. In another embodiment, a linear light guide with non-parallel side faces is combined with a particularly shaped reflector. The particular features result in efficient light extraction from linear light guides.

This application claims priority from provisional patent application number 669/MUM/2009 filed on 23 Mar. 2009 at Mumbai, India and also from provisional patent application number 1942/MUM/2009 filed on 24 Aug. 2009 at Mumbai, India.

### FIELD OF THE INVENTION

The present invention relates to light sources. More particularly, the invention relates to linear light sources with features that provide enhanced light extraction.

### BACKGROUND

Light sources formed out of linear light guides have been previously disclosed. Linear light guides are light guides with one dimension substantially larger than the other two dimensions. The light sources formed from these light guides have structures embedded within the light guides that deflect or scatter light.

### SUMMARY

Linear light sources with features that enhance light extraction are disclosed. In an embodiment, a linear light guide with one or more reflective faces is oriented in such a manner that deflected light undergoes reduced reflections. In another embodiment, a linear light guide with non-parallel side faces is combined with a particularly shaped reflector. The particular features result in efficient light extraction from linear light guides.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiments given below serve to explain and teach the principles of the present invention.

FIG. 1A illustrates a block diagram of an exemplary linear light guide.

FIG. 1B illustrates the path taken by an exemplary light ray within an exemplary linear light source.

FIG. 1C illustrates the side view of the path taken by an exemplary light ray within an exemplary linear light source.

FIG. 2 illustrates a block diagram of an exemplary linear light guide, according to one embodiment.

FIG. 3 illustrates the side view of an exemplary reflector, according to one embodiment.

FIG. 4 illustrates the side view of the path taken by an exemplary scattered light ray within an exemplary linear light source, according to one embodiment.

FIG. 5 illustrates the side view of an exemplary reflector, according to one embodiment.

FIG. 6 illustrates the side view of the path taken by an exemplary scattered light ray within an exemplary linear light source, according to one embodiment.

FIG. 7 illustrates a block diagram of an exemplary linear light guide, according to one embodiment.

FIG. 8 illustrates the side view of an exemplary reflector, according to one embodiment.

FIG. 9 illustrates the side view of the path taken by an exemplary scattered light ray within an exemplary linear light source, according to one embodiment.

FIG. 10 illustrates a block diagram of an exemplary linear light guide, according to one embodiment.

FIG. 11 illustrates a block diagram of an exemplary reflector, according to one embodiment.

FIG. 12 illustrates a block diagram of an exemplary linear light guide, according to one embodiment.

FIG. 13 illustrates a block diagram of an exemplary reflector, according to one embodiment.

FIG. 14 illustrates the side view of the path taken by an exemplary scattered light ray within an exemplary linear light source, according to one embodiment.

FIG. 15 illustrates a block diagram of an exemplary reflector, according to one embodiment.

FIG. 16 illustrates the side view of the path taken by an exemplary scattered light ray within an exemplary linear light source, according to an embodiment.

FIG. 17 illustrates a block diagram of an exemplary linear light guide, according to one embodiment.

FIG. 18 illustrates the side view of the path taken by an exemplary scattered light ray within an exemplary linear light source, according to one embodiment.

FIG. 19 illustrates a block diagram of an exemplary linear light guide, according to one embodiment.

FIG. 20 illustrates a block diagram of an exemplary reflector, according to one embodiment.

FIG. 21 illustrates the side view of the path taken by an exemplary scattered light ray within an exemplary linear light source, according to one embodiment.

FIG. 22 illustrates a block diagram of an exemplary linear light guide, according to one embodiment.

FIG. 23 illustrates a block diagram of an exemplary reflector, according to one embodiment.

FIG. 24 illustrates the side view of the path taken by an exemplary scattered light ray within an exemplary linear light source, according to one embodiment.

FIG. 25 illustrates a block diagram of an exemplary linear light guide, according to one embodiment.

FIG. 26 illustrates a block diagram of an exemplary reflector, according to one embodiment.

FIG. 27 illustrates the side view of the path taken by an exemplary scattered light ray within an exemplary linear light source, according to one embodiment.

FIG. 28 illustrates the side view of the path taken by an exemplary scattered light ray within an exemplary linear light source, according to an embodiment.

FIG. 29 illustrates a block diagram of an exemplary linear light guide, according to one embodiment.

FIG. 30 illustrates a block diagram of an exemplary reflector, according to one embodiment.

FIG. 31 illustrates the side view of the path taken by an exemplary scattered light ray within an exemplary linear light source, according to an embodiment.

FIG. 32 illustrates a block diagram of an exemplary linear light guide, according to one embodiment.

FIG. 33 illustrates the side view of the path taken by an exemplary scattered light ray within an exemplary linear light source, according to an embodiment.

FIG. 34 illustrates a block diagram of an exemplary linear light guide, according to one embodiment.

FIG. 35 illustrates a block diagram of an exemplary reflector, according to one embodiment.

FIG. 36 illustrates the side view of the path taken by an exemplary scattered light ray within an exemplary linear light source, according to an embodiment.

FIG. 37 illustrates a block diagram of an exemplary linear light guide, according to one embodiment.

FIG. 38 illustrates the side view of the path taken by an exemplary scattered light ray within an exemplary linear light source, according to an embodiment.

FIG. 39 illustrates the side view of the path taken by an exemplary scattered light ray within an exemplary linear light source, according to an embodiment.

FIG. 40 illustrates a block diagram of an exemplary linear light guide, according to one embodiment.

FIG. 41 illustrates a block diagram of an exemplary reflector, according to one embodiment.

FIG. 42 illustrates the side view of the path taken by an exemplary scattered light ray within an exemplary linear light source, according to an embodiment.

FIG. 43 illustrates the side view of the path taken by an exemplary scattered light ray within an exemplary linear light source, according to an embodiment.

FIG. 44 illustrates a block diagram of an exemplary linear light guide, according to one embodiment.

FIG. 45 illustrates a block diagram of an exemplary reflector, according to one embodiment.

FIG. 46 illustrates the side view of the path taken by an exemplary scattered light ray within an exemplary linear light source, according to an embodiment.

FIG. 47 illustrates a block diagram of an exemplary linear light guide, according to one embodiment.

FIG. 48 illustrates a block diagram of an exemplary reflector, according to one embodiment.

FIG. 49 illustrates the side view of the path taken by an exemplary scattered light ray within an exemplary linear light source, according to an embodiment.

FIG. 50 illustrates a block diagram of an exemplary linear light guide, according to one embodiment.

FIG. 51 illustrates a block diagram of the cross-section of an exemplary reflector, according to one embodiment.

FIG. 52 illustrates the side view of the path taken by an exemplary scattered light ray within an exemplary linear light source, according to one embodiment.

FIG. 53 illustrates a block diagram of an exemplary linear light guide, according to one embodiment.

FIG. 54 illustrates a block diagram of the cross-section of an exemplary reflector, according to one embodiment.

FIG. 55 illustrates the side view of the path taken by an exemplary scattered light ray within an exemplary linear light source, according to one embodiment.

FIG. 56 illustrates a linear light source, according to one embodiment.

FIG. 57 illustrates a linear light source, according to one embodiment.

FIG. 58 illustrates a surface light source, according to one embodiment.

FIG. 59 illustrates a surface light source, according to one embodiment.

FIG. 60 illustrates an exemplary element of a light guide having light deflector, according to one embodiment.

FIG. 61 illustrates an exemplary light source having a varied concentration of light deflecting particles, according to one embodiment.

FIG. 62 illustrates an exemplary light source having two light sources, according to one embodiment.

FIG. 63 illustrates an exemplary light source having a mirrored light guide, according to one embodiment.

### DETAILED DESCRIPTION

Linear light sources with features that enhance light extraction are disclosed. In an embodiment, a linear light guide with one or more reflective faces is oriented in such a manner that deflected light undergoes reduced reflections. In another embodiment, a linear light guide with non-parallel side faces is combined with a particularly shaped reflector. The particular features result in efficient light extraction from linear light guides.

### GLOSSARY OF TERMS

A reflector is any means of reflecting light. Specular light reflectors or mirrors include metallic surfaces, distributed Bragg reflectors, hybrid reflectors, total internal reflectors or omni-directional reflectors. Diffuse light reflectors include paints, suspensions of transparent materials, dyes, etc.
A point light source is a light source emitting light from a small region. E.g. an LED (Light Emitting Diode), a LASER (Light Amplification by Stimulated Emission of Radiation) or a filament can act as a point light source. A small linear or surface light source (described below) can also be considered to be a point light source when viewed from afar, or when emitting light into a much larger body.
A linear light source is a light source emitting light from a region which has one large dimension. A linear light source could be shaped like a tube with circular, square or other cross section, for example. A linear light source could be shaped like a prism having a particular cross section (polygonal or curved, curvilinear, etc.)
A surface light source is a light source emitting light from a region which has two large dimensions. A surface light source will have at least one large light emitting surface. It may have a small thickness, i.e. it may be in the form of a sheet.
A light guide is an object which guides light within it. A light guide may comprise a transparent material of a refractive index larger than the refractive index of a surrounding material, and will guide light by total internal reflection. A light guide may also comprise a reflective cavity, and will guide light by reflection. A light guide may be augmented by features such as light deflectors which deflect the light out of the light guide, so that the light guide acts as a light source. The light guide may be placed in a reflecting cavity so that the light is emanated preferentially in certain directions. The reflectors may be placed close to the surface of the light guide, with a small gap of air, or vacuum or lower refractive index material to facilitate total internal reflection at the surface of the light guide. Alternatively, the reflectors of the reflecting cavity may be optically bonded to the surface of the light guide. The reflector may be deposited directly on the surface of the light guide.
A light deflector is an element that deflects light traveling within a light guide. A light deflector may be a small transparent particle or bubble, which deflects light incident on it by refraction, reflection at the boundary, by diffusion inside the particle, by scattering, or by total internal reflection. A light deflector may be a transparent particle with a different refractive index than the surrounding medium. A light deflector may be a spherical or an aspherical particle. Light deflectors may be aspherical particles embedded in a specific orientation with respect to the light guide. Light deflectors may change the wavelength of light. For example a light deflector may contain photoluminescent material. Light deflectors may be irregularities or small white dots or geometric shapes, such as prisms or lenses.
A linear light guide is a light guide with one large dimension.
A sheet light guide is a light guide with two large dimensions.

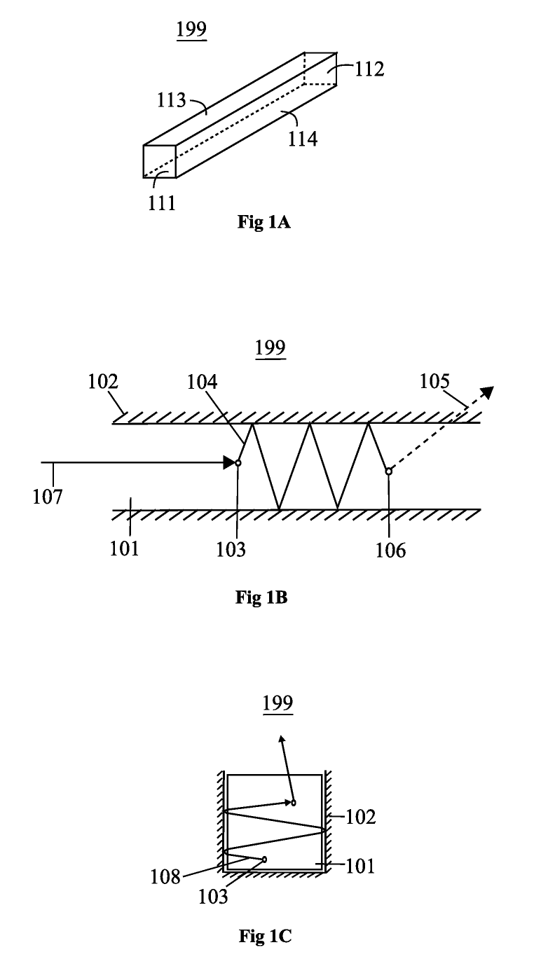

FIG. 1A illustrates a block diagram of an exemplary linear light guide 199. The linear light guide 199 is in the form of a cuboid with a square cross-section. Light from a light source may enter face 111 and travel through the light guide towards the face 112. If the linear light guide 199 comprises light deflectors, then the traveling light may encounter a light deflector and may be extracted out of the other faces such as 113 and 114.

Linear light guides having light deflectors deflect light into a required direction of emission, and possibly also into other directions. Light scattered into directions other than the required direction of emission can be utilized by making the light guide reflective in those other directions. Light scattered towards a reflective wall of the linear light guide will undergo multiple reflections and may be absorbed before another scattering event can extract it.

FIG. 1B illustrates the path taken by an exemplary light ray 107 within an exemplary linear light source 199. The linear light source 199 comprises a linear light guide 101 with a square cross-section and reflectors 102 on three of its faces. Light deflectors such as 103 and 106 are embedded within the light guide 101. An exemplary incoming light ray 107, is scattered due to a light deflector 103 and is reflected off the reflectors 102 multiple times as it travels through the light guide 101. On encountering light deflector 106, the light ray is extracted out of the non-reflective face of the light guide 101 as light ray 105.

FIG. 1C illustrates the side view of the path taken by an exemplary light ray 108 within an exemplary linear light source 199. Light ray 108, while traversing the long dimension of the linear light guide 101, is reflected multiple times from the reflectors 102 before exiting out of the non-reflective face. In an embodiment, the light ray 108 is generated due to deflection from a deflector 103 and may also exit the light guide due to another scattering event.

Such multiple reflections of a light ray leads to a diminished, or in some cases no extraction of the light ray out of the light guide. About 50% of the deflected light rays will face this problem.

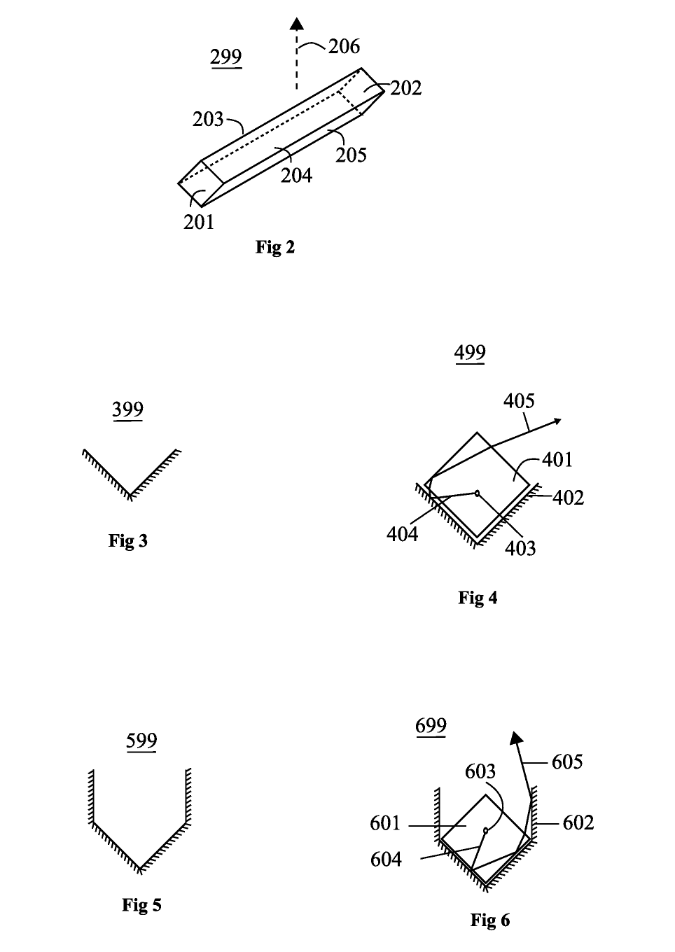

FIG. 2 illustrates a block diagram of an exemplary linear light guide 299, according to one embodiment. The linear light guide 299 is in the form of a prism with a square cross-section. Depicted direction 206 is a principal direction of light extraction, i.e. useful light is to be extracted along and around this direction. For example, in the case that the linear light source acts as a light source for a surface light source, the linear light source is situated along an edge of the surface light source, and the large faces of the surface light source are parallel to the principal direction of light extraction 206. The linear light guide 299 is oriented in such a way that some of its long faces such as face 205 form an angle of 45 degrees with the principal direction of light extraction. Light from a light source can enter face 201 and travel through the light guide towards the face 202. The linear light guide 299 comprises light deflectors, so the traveling light may encounter a light deflector and may be extracted out of the others. faces such as 203 and 204. Most light deflected by a light deflector, that is deflected in a direction close to normal to the axis of the linear light guide 299, will emanate out of the linear light guide 299.

FIG. 3 illustrates the side view of an exemplary reflector 399, according to one embodiment. The reflector 399 is extended in one direction and has a V-shaped cross-section, i.e. the reflector 399 is a V-shaped groove.

FIG. 4 illustrates the side view of the path taken by an exemplary scattered light ray 404 within an exemplary linear light source 499, according to one embodiment. A linear light guide 401 in the shape of a prism with a square cross-section is oriented in such a way that the sides of the square cross-section form an angle of 45 degrees with a principal direction of light extraction. A V-shaped reflector 402 covers two sides of the linear light guide 401 that are towards the bottom. An exemplary light ray 404 is generated due to deflection from a light deflector 403. The light ray 404 refracted out of the linear light guide 401, encounters the reflector 402 and is reflected back inside. The reflected ray then travels out of the linear light guide 401 as light ray 405. The presence of the reflector at the bottom allows the retrieval of light traveling in the downward direction. The absence of reflector in any two sections that are parallel to each other reduces the number of bounces that the deflected light will undergo.

FIG. 5 illustrates the side view of an exemplary reflector 599, according to one embodiment. The reflector 599 is vertically extended, i.e. it has a cross-section that is similar to the alphabet V with its two lines extended vertically up. The extensions may be parallel to each other or slanting to each other.

FIG. 6 illustrates the side view of the path taken by an exemplary scattered light ray 604 within an exemplary linear light source 699, according to one embodiment. A linear light guide 601 in the shape of a prism with a square cross-section is oriented in such a way that the sides of the square cross-section form an angle of 45 degrees with a principal direction of light extraction. A vertically extended V-shaped reflector 602 placed close to the two bottom faces of the linear light guide 601, extends up over the other faces too. An exemplary light ray 604 is generated due to deflection from a light deflector 603. The light ray 604 undergoes reflection due to the reflector 602, followed by total internal reflection within the light guide and finally a reflection off the vertically extended portion of the reflector 602 to come out of the light guide 601 in the upward direction. The vertically extended reflector helps in guiding the extracted light in such a manner that it emanates out of a narrower aperture, so that a thinner surface light guide may be coupled to this linear light source 699 with high efficiency.

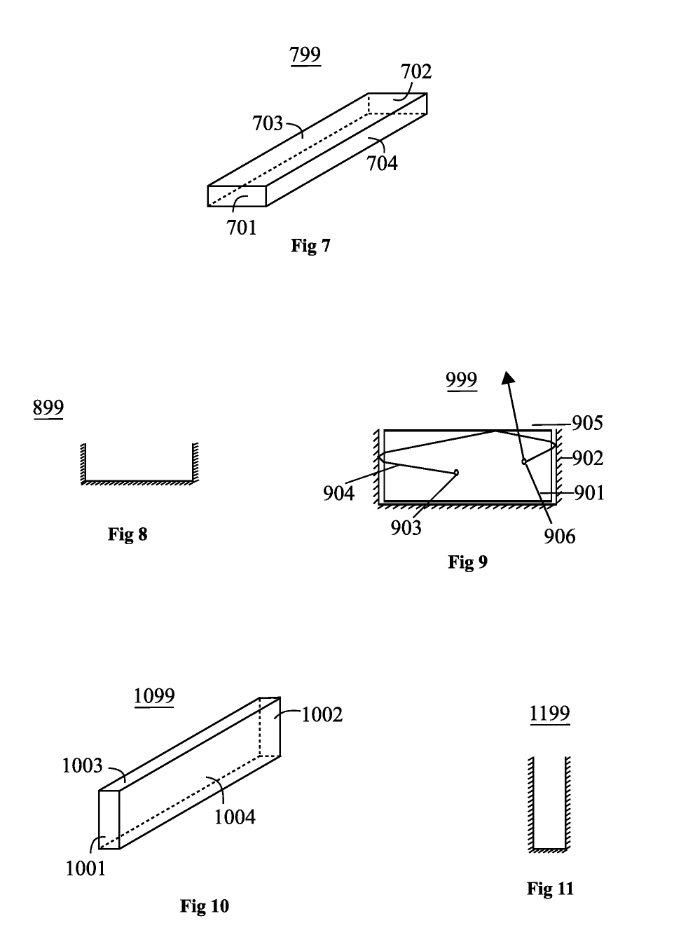

FIG. 7 illustrates a block diagram of an exemplary linear light guide 799, according to one embodiment. The linear light guide 799 is in the form of a prism with a rectangular cross-section. The thinner faces of the linear light guide 799, such as face 704 are perpendicular to the wider faces such as face 703, which are towards the top and bottom. This shape and orientation of the linear light guide 799 results in a small height, which in turn results in lesser number of internal reflections between the side walls of the linear light guide 799. Light from a light source can enter face 701 and travel through the light guide towards the face 702. The linear light guide 799 comprises light deflectors, so the traveling light may encounter a light deflector and may be extracted out of the other faces such as face 703.

FIG. 8 illustrates the side view of an exemplary reflector 899, according to one embodiment. The reflector 899 has a cross-section that is a rectangle whose longer edges are towards the top and bottom and whose top edge is removed.

FIG. 9 illustrates the side view of the path taken by an exemplary scattered light ray 904 within an exemplary linear light source 999, according to one embodiment. A linear light guide 901 in the shape of a prism with a rectangular cross-section is covered by reflector 902 on three sides. An exemplary light ray 904 is generated due to deflection from a light deflector 903. The light ray 904 refracted out of the linear light guide 901, encounters the reflector 902 and is reflected back inside. The reflected ray further encounters total internal reflection at the top and bottom faces and reflection at the side faces due to reflector 902 till it meets a light deflector 906 and is possibly deflected out of the light guide 901. The reduced height of the linear light guide 901 due to its rectangular cross-section results in lesser reflections at the reflector 902 before the light is extracted out.

FIG. 10 illustrates a block diagram of an exemplary linear light guide 1099, according to one embodiment. The linear light guide 1099 is in the form of a prism with a rectangular cross-section. The wider faces of the linear light guide 1099, such as face 1004 are perpendicular to the thinner faces such as face 1003, which are towards the top and bottom. This shape and orientation of the linear light guide 1099 allows the coupling of a thin sheet light guide on top of the linear light guide 1099. Light from a light source can enter face 1001 and travel through the linear light guide 1099 towards the face 1002. Since the linear light guide 1099 comprises light deflectors, the traveling light may encounter a light deflector and may be extracted out of the other faces such as face 1003.

FIG. 11 illustrates a block diagram of an exemplary reflector 1199, according to one embodiment. The reflector 1199 is extended in one direction and has a cross-section that is a rectangle whose shorter edges are towards the top and bottom and whose top edge is removed. A linear light source in the form of a prism with a rectangular cross-section may be placed inside the reflector 1199.

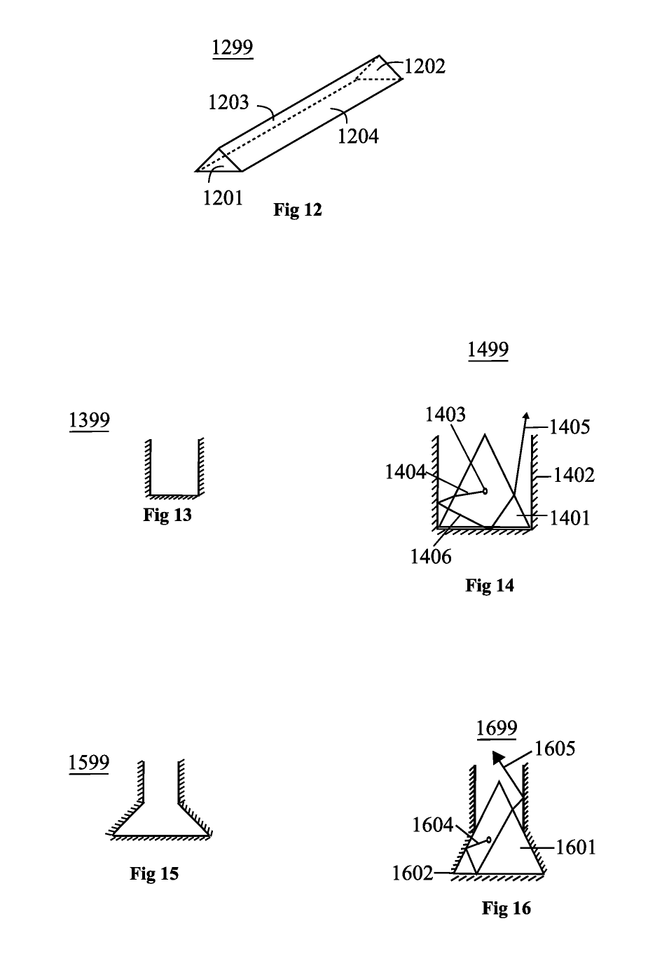

FIG. 12 illustrates a block diagram of an exemplary linear light guide 1299, according to one embodiment. The linear light guide 1299 has a triangular cross-section and is oriented in such a way that one of the three long faces is towards the bottom while one of the three long edges is towards the top. In an embodiment, the angle made by the top two faces with each other is 90 degrees. Light from a light source can enter face 1201 and travel through the linear light guide 1299 towards the face 1202. Since the linear light guide 1299 comprises light deflectors, the traveling light may encounter a light deflector and may be extracted out of the other faces such as face 1203 and face 1204. In an embodiment, the angle between the two faces 1203 and 1204 is 90 degrees. In another embodiment, it is 60 degrees.

FIG. 13 illustrates a block diagram of an exemplary reflector 1399, according to one embodiment. The reflector 1399 is extended in one direction and has a cross-section that is a square or a rectangle without it's top edge.

FIG. 14 illustrates the side view of the path taken by an exemplary scattered light ray 1404 within an exemplary linear light source 1499, according to one embodiment. A linear light guide 1401 with a triangular cross-section is oriented in such a way that one of the corners of the triangle points upwards. The linear light guide 1401 is placed within a three sided reflector 1402. The reflector 1402 has a cross-section that is a square or a rectangle without a top edge. An exemplary light ray 1404 is generated due to deflection from a light deflector 1403. The light ray 1404 refracted out of the linear light guide 1401, encounters the reflector 1402 and is reflected back inside as light ray 1406. Light ray 1406 further undergoes reflection due to the reflector 1402 covering the bottom wall of the linear light guide 1401 and then comes out as light ray 1405. The three sided reflector 1402 helps in extracting more light in an upward direction. Even though the reflector 1402 may have parallel walls, the corresponding faces of the linear light guide 1401 are non-parallel, which reduces the number of times the light will bounce between the parallel faces of the reflector.

FIG. 15 illustrates a block diagram of an exemplary reflector 1599, according to one embodiment. The reflector 1599 is extended in one direction and has an inverted funnel shaped cross-section. In other words, the cross section is that of a trapezium whose shorter side has been removed, and the slant sides have been vertically extended, away from the longer side of the trapezium, and in an embodiment perpendicular to the longer side of the trapezium.

FIG. 16 illustrates the side view of the path taken by an exemplary scattered light ray 1604 within an exemplary linear light source 1699, according to an embodiment. A linear light guide 1601 with a triangular cross-section is oriented in such a way that one of the corners of the triangle point upwards. The linear light guide 1601 is placed within an inverted funnel shaped reflector 1602. An exemplary light ray 1604 is generated due to deflection from a light deflector 1603. The light ray 1604 undergoes multiple reflections on the reflector 1602 before exiting out of the light guide where it is reflected off the extended portion of the reflector 1602 into an upward direction 1605. The mirror 1602 has a narrower opening, and thus the light may be coupled into a narrower surface light guide. In an embodiment, a slant side of the reflector 1602 is parallel to a side of the linear light guide 1601. In another embodiment, they have different slopes.

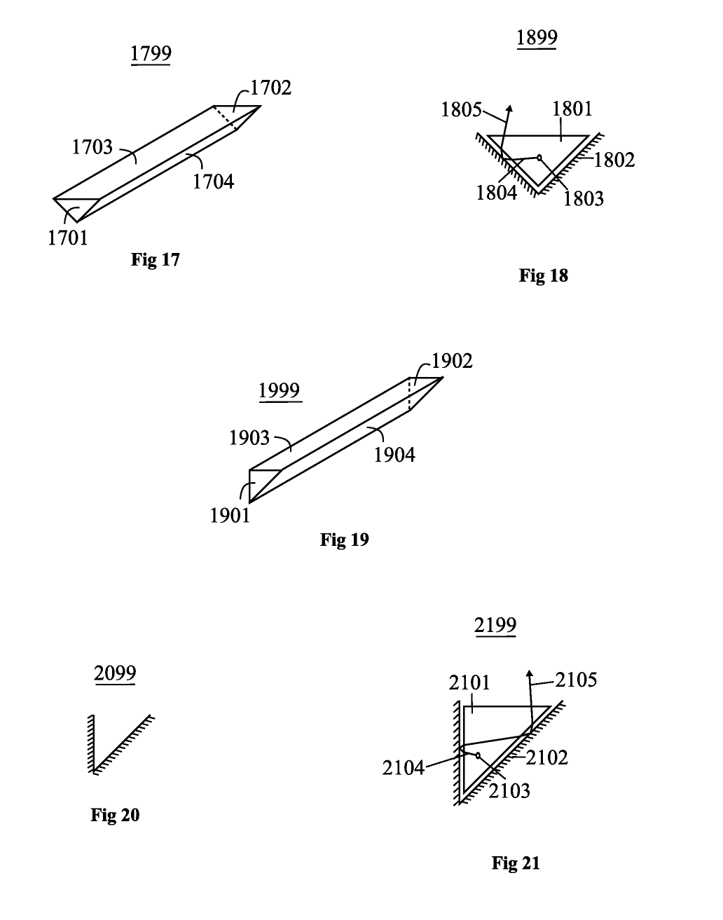

FIG. 17 illustrates a block diagram of an exemplary linear light guide 1799, according to one embodiment. The linear light guide 1799 has a triangular cross-section and is oriented in such a way that one of the three long faces is facing upwards while one of the three long edges is towards the bottom. In an embodiment, the angle made by the bottom two faces with each other is 90 degrees. Light from a light source can enter face 1701 and travel through the linear light guide 1799 towards the face 1702. Since the linear light guide 1799 comprises light deflectors, the traveling light may encounter a light deflector and may be extracted out of faces such as face 1703 and face 1704. In an embodiment, the angle between the two slanted faces (bottom faces) is 90 degrees. In another embodiment, it is 60 degrees.

FIG. 18 illustrates the side view of the path taken by an exemplary scattered light ray 1804 within an exemplary linear light source 1899, according to one embodiment. A linear light guide 1801 with a triangular cross-section is oriented in such a way that one of the corners of the triangle points downwards. The linear light guide 1801 is placed within V-shaped reflector 1802. An exemplary light ray 1804 is generated due to deflection from a light deflector 1803. The light ray 1804 refracted out of the linear light guide 1801, encounters the reflector 1802 and is reflected back inside the light guide and finally out as light ray 1805. The presence of the reflector helps in extracting more of the light in an upward direction.

FIG. 19 illustrates a block diagram of an exemplary linear light guide 1999, according to one embodiment. The linear light guide 1999 has a cross-section which is a right-angled triangle. The linear light guide 1999 is oriented in such a way that one of the two long faces forming the right angle such as face 1903 is facing upwards. Light from a light source can enter face 1901 and travel through the linear light guide 1999 towards the face 1902. Since the linear light guide 1999 comprises light deflectors, the traveling light may encounter a light deflector and may be extracted out of faces such as face 1903 and face 1904. In an embodiment, the angle between the slant face 1904 and the horizontal face 1903 is 30 degrees, 45 degrees or 60 degrees.

FIG. 20 illustrates a block diagram of an exemplary reflector 2199, according to one embodiment. The reflector 2199 is extended in one direction and has a cross-section that is a right-angled triangle without a top (shorter) edge. The reflector 2199 is oriented in such a way that one of the non-right-angled corners of the triangular cross-section points downwards.

FIG. 21 illustrates the side view of the path taken by an exemplary scattered light ray 2104 within an exemplary linear light source 2199, according to one embodiment. A linear light guide 2101 with a right-angled triangle for a cross-section, is oriented in such a way that one of the two long faces forming the right angle is facing upwards. The linear light guide 2101 is placed within a right-angled triangle shaped reflector 2102 that properly fits around the light guide. An exemplary light ray 2104 is generated due to deflection from a light deflector 2103. The light ray 2104 undergoes multiple reflections off the reflector 2102 to finally come out of the light guide 2101 as light ray 2105. The non-parallel edges of the light guide 2101 and reflector 2102 result in a reduced number of reflections within the reflector cavity before a light ray is extracted out.

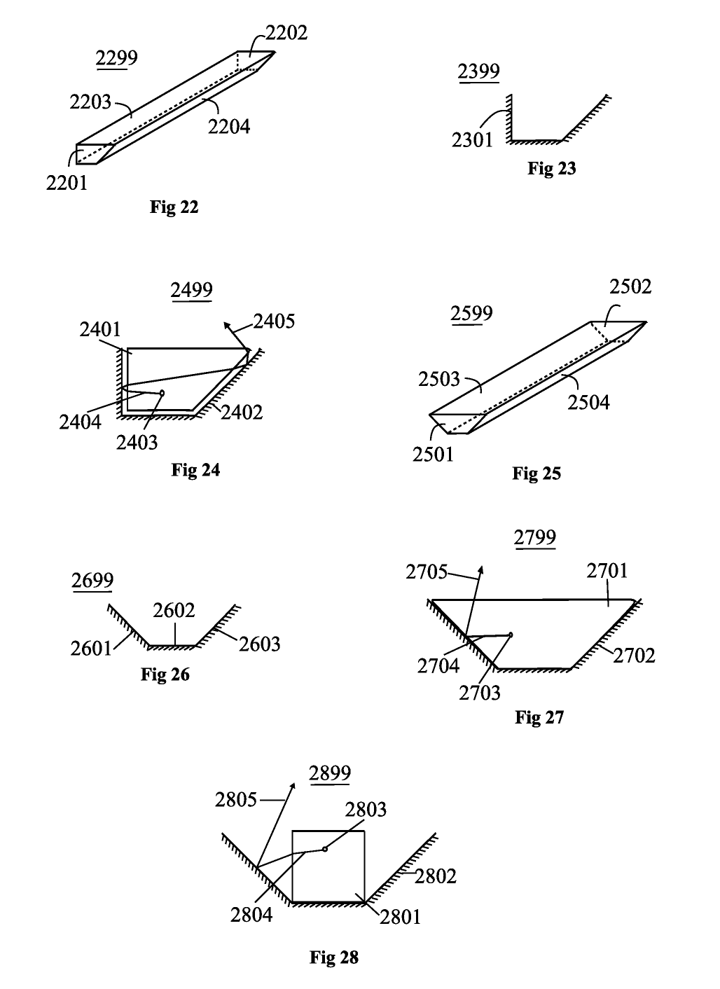

FIG. 22 illustrates a block diagram of an exemplary linear light guide 2299, according to one embodiment. The linear light guide 2299 has a trapezoidal cross-section and is oriented in such a way that the two parallel sides are towards the top and bottom. The side towards the top is bigger than the side towards the bottom and one of the non-parallel edges is perpendicular to the parallel edges. Light from a light source can enter face 2201 and travel through the linear light guide 2299 towards the face 2202. Since the linear light guide 2299 comprises light deflectors, the traveling light may encounter a light deflector and may be extracted out of faces such as face 2203 and face 2204. In an embodiment, the angle between the slant face 2204 and the bottom horizontal face is 90+180/n, where n is an integer greater than 2.

FIG. 23 illustrates a block diagram of an exemplary reflector 2399, according to one embodiment. The reflector 2399 is extended in one direction and has a cross-section that is a trapezoid without a top edge. The parallel edges of the trapezoid are towards the top and bottom with the smaller edge towards the bottom. One of the non-parallel edges, edge 2301 is perpendicular to the parallel edges. In an embodiment, the angle between the slant edge and the bottom edge is 90+180/n, where n is an integer greater than 2.

FIG. 24 illustrates the side view of the path taken by an exemplary scattered light ray 2404 within an exemplary linear light source 2499, according to one embodiment. A linear light guide 2401 has a trapezoidal cross-section and is oriented in such a way that the two parallel sides are towards the top and bottom. The side towards the top is bigger than the side towards the bottom and one of the non-parallel edges is perpendicular to the parallel edges. The linear light guide 2401 is placed within a three-sided trapezoidal reflector 2402 that properly fits around the bottom three faces of the light guide. An exemplary light ray 2404 is generated due to deflection from a light deflector 2403. The light ray 2404 undergoes multiple reflections off the reflector 2402 to come out of the light guide 2401 as light ray 2405. The non-parallel edges and the absence of small-angles corners in the light guide 2401 result in a reduced number of reflections within the reflector cavity before a light ray is extracted out.

FIG. 25 illustrates a block diagram of an exemplary linear light guide 2599, according to one embodiment. The linear light guide 2599 has a cross-section which is a trapezoid. The linear light guide 2599 is oriented in such a way that the two parallel faces are towards the top and bottom. The side towards the top is bigger than the side towards the bottom. Light from a light source can enter face 2501 and travel through the linear light guide 2599 towards the face 2502. Since the linear light guide 2599 comprises light deflectors, the traveling light may encounter a light deflector and may be extracted out of faces such as face 2503 and face 2504. In an embodiment, the angle between a slant face such as face 2504 and the bottom horizontal face is 90+180/n, where n is an integer greater than 2. In an embodiment, both the slant faces make the same angle with the horizontal face.

FIG. 26 illustrates a block diagram of an exemplary reflector 2699, according to one embodiment. The reflector 2699 is extended in one direction and has a cross-section that is a trapezoid without a top edge. The parallel edges, such as edge 2602 of the trapezoid are towards the top and bottom with the smaller edge towards the bottom. In an embodiment the non-parallel edges, such as edge 2601 form an angle of 135 degrees with the parallel edge 2602. In an embodiment the said internal angle is calculated as 90+180/n where n is an integer greater than 2.

FIG. 27 illustrates the side view of the path taken by an exemplary scattered light ray 2704 within an exemplary linear light source 2799, according to one embodiment. A linear light guide 2701 has a trapezoidal cross-section and is oriented in such a way that the two parallel sides are towards the top and bottom. The side towards the top is bigger than the side towards the bottom. The linear light guide 2701 is placed within a three-sided trapezoidal reflector 2702 that properly fits around the bottom three faces of the light guide. An exemplary light ray 2704 is generated due to deflection from a light deflector 2703. The light ray 2704 reflects off the reflector 2702 to come out of the light guide 2701 as light ray 2705. The non-parallel edges and the absence of small-angles corners in the light guide 2701 result in a reduced number of reflections within the reflector cavity before a light ray is extracted out.

FIG. 28 illustrates the side view of the path taken by an exemplary scattered light ray 2804 within an exemplary linear light source 2899, according to an embodiment. A linear light guide 2801 has a prism shape with a square cross-section. It is placed within a trapezoidal reflector 2802. An exemplary light ray 2804 is generated due to deflection from a light deflector 2803. The light ray 2804 traveling out of the side of the linear light guide 2801 undergoes refraction at the boundary of the linear light guide, followed by reflection off the reflector 2802, to come out as light 2805 in the upward direction.

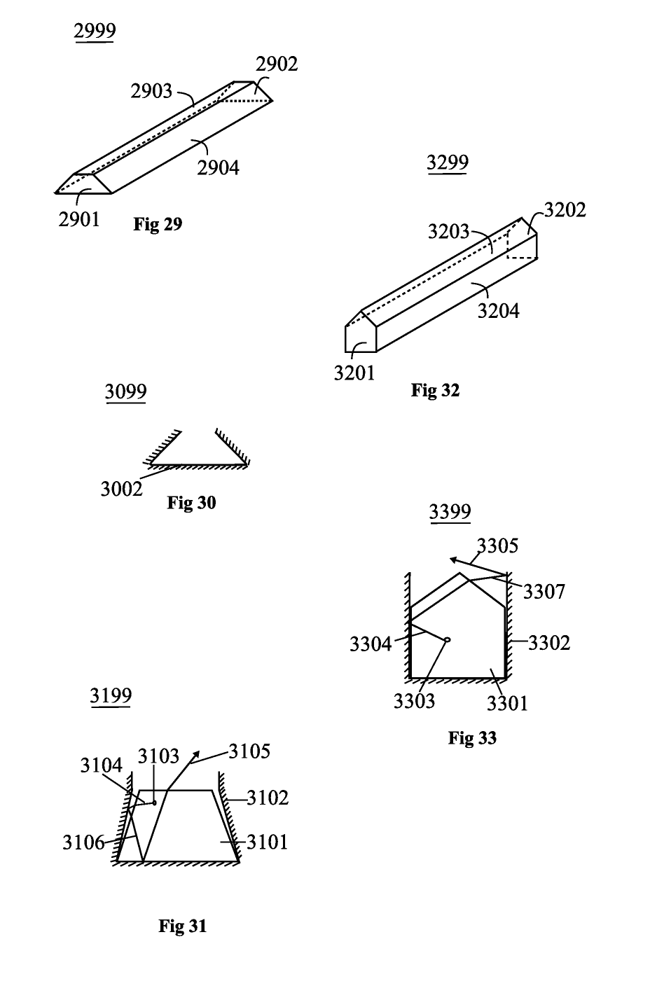

FIG. 29 illustrates a block diagram of an exemplary linear light guide 2999, according to one embodiment. The linear light guide 2999 has a cross-section which is a trapezoid. The linear light guide 2999 is oriented in such a way that the two parallel faces are towards the top and bottom. The side towards the top is smaller than the side towards the bottom. This arrangement of smaller side to the top allows the coupling of a thinner surface light source to the top of the linear light guide 2999. Light from a light source can enter face 2901 and travel through the linear light guide 2999 towards the face 2902. Since the linear light guide 2999 comprises light deflectors, the traveling light may encounter a light deflector and may be extracted out of faces such as face 2903 and face 2904. In an embodiment, the angle between the slant face such as face 2904 and the top horizontal face 2903 is 90+180/n, where n is an integer greater than 2.

FIG. 30 illustrates a block diagram of an exemplary reflector 3099, according to one embodiment. The reflector 3099 is extended in one direction and has a cross-section that is a trapezoid without a top edge. The parallel edges, such as edge 3002 of the trapezoid are towards the top and bottom with the larger edge towards the bottom and the smaller edge non-existent.

FIG. 31 illustrates the side view of the path taken by an exemplary scattered light ray 3104 within an exemplary linear light source 3199, according to an embodiment. A linear light guide 3101 has a prism shape with a trapezoidal cross-section. It is placed within a trapezoidal reflector 3102. An exemplary light ray 3104 is generated due to deflection from a light deflector 3103. The light ray 3104 traveling out of the side of the linear light guide 3101 undergoes refraction at the boundary of the linear light guide, followed by reflection off the reflector 3102, to reenter the light guide 3101 as light ray 3106. Light ray 3106 may undergo further reflections off the reflector 3102 before exiting as light ray 3105. In an embodiment, the side walls of the reflector 3102 make a larger angle with the bottom wall than the side walls of the linear light guide 3101. In an embodiment, the angle between the slant face and the top horizontal face of the reflector or the light guide is 90+180/n, where n is an integer greater than 2.

FIG. 32 illustrates a block diagram of an exemplary linear light guide 3299, according to one embodiment. The linear light guide 3299 has a cross-section that is a pentagon formed by replacing the top edge of a square by two symmetrical edges of a triangle. Such a cross-sectional shape allows upward traveling light to be focused in a narrower cone of directions. Light from a light source can enter face 3201 and travel through the linear light guide 3299 towards the face 3202. Since the linear light guide 3299 comprises light deflectors, the traveling light may encounter a light deflector and may be extracted out of faces such as face 3203 and face 3204. In an embodiment, the angle between the two top slanted faces is 360/n, where n is an integer greater than 2.

FIG. 33 illustrates the side view of the path taken by an exemplary scattered light ray 3304 within an exemplary linear light source 3399, according to an embodiment. A linear light guide 3301 has a cross-section that is a pentagon formed by replacing the top edge of a square by two symmetrical edges of a triangle. It is placed within a three-sided reflector 3302. An exemplary light ray 3304 is generated due to deflection from a light deflector 3303. The light ray 3304 reflects off the reflector 3302 to reenter the light guide 3301 and then exit out of one of the top edges. The exiting ray 3307 is reflected off the extended portion of the reflector 3302 to form light ray 3305. In an embodiment, the walls of the reflector extend in height to or beyond the topmost point of the cross section of the linear light source.

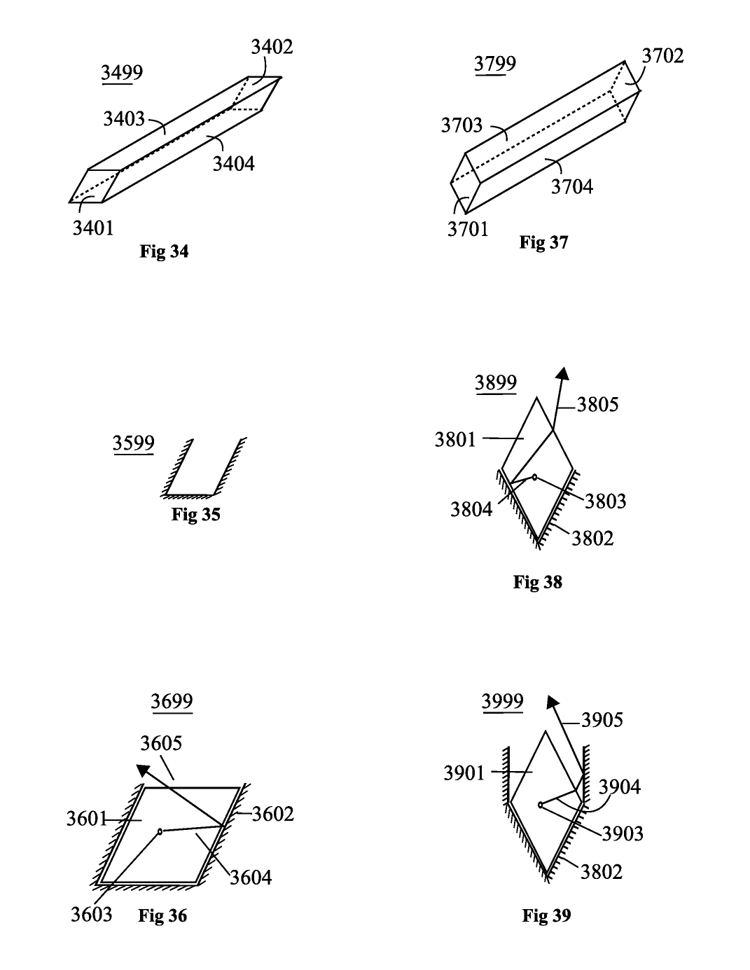

FIG. 34 illustrates a block diagram of an exemplary linear light guide 3499, according to one embodiment. The linear light guide 3499 has a cross-section that is a parallelogram. Light from a light source can enter face 3401 and travel through the linear light guide 3499 towards the face 3402. Since the linear light guide 3499 comprises light deflectors, the traveling light may encounter a light deflector and may be extracted out of faces such as face 3403 and face 3404. The top face is small, so a thinner surface light source may be coupled to this embodiment.

FIG. 35 illustrates a block diagram of an exemplary reflector 3599, according to one embodiment. The reflector 3599 is extended in one direction and has a cross-section that is a parallelogram without a top edge.

FIG. 36 illustrates the side view of the path taken by an exemplary scattered light ray 3604 within an exemplary linear light source 3699, according to an embodiment. A linear light guide 3601 has a cross-section that is a parallelogram. It is placed within a three-sided reflector 3602 which also has a parallelogram for its cross-section. An exemplary light ray 3604 is generated due to deflection from a light deflector 3603. The light ray 3604 reflects off the reflector 3602 to reenter the light guide 3601 and then exit out of one of the top edges as light ray 3605. The fact that the faces of linear light guide 3604 are not perpendicular at the corners reduces multiple reflections within the reflector cavity. Using a parallelogram gives a small surface of light output, from which coupling to a thin surface light guide may be achieved efficiently.

FIG. 37 illustrates a block diagram of an exemplary linear light guide 3799, according to one embodiment. The linear light guide 3799 has a cross-section that is a rhombus. The rhombus is oriented in such a way that the two small interior angles of the rhombus are towards the top and bottom, while the remaining two bigger angles are towards the sides. Light from a light source can enter face 3701 and travel through the linear light guide 3799 towards the face 3702. Since the linear light guide 3799 comprises light deflectors, the traveling light may encounter a light deflector and may be extracted out of faces such as face 3703 and face 3704. In an embodiment, the angle between the top two faces is 60 degrees.

FIG. 38 illustrates the side view of the path taken by an exemplary scattered light ray 3804 within an exemplary linear light source 3899, according to an embodiment. A linear light guide 3801 has a cross-section that is a rhombus and is oriented in such a way that the two small interior angles of the rhombus are towards the top and bottom, while the remaining two bigger angles are towards the sides. It is placed within a V-shaped reflector 3802. An exemplary light ray 3804 is generated due to deflection from a light deflector 3803. The light ray 3804 reflects off the reflector 3802 to reenter the light guide 3801 and then exit out of one of the top edges as light ray 3805.

FIG. 39 illustrates the side view of the path taken by an exemplary scattered light ray 3904 within an exemplary linear light source 3999, according to an embodiment. A linear light guide 3901 has a cross-section that is a rhombus and is oriented in such a way that the two small interior angles of the rhombus are towards the top and bottom, while the remaining two bigger angles are towards the sides. It is placed within an extended V-shaped reflector 3902. An exemplary light ray 3904 is generated due to deflection from a light deflector 3903. The light ray 3904 refracts out of the linear light guide 3901 and hits the extended portion of the reflector 3902 to come out in an upward direction as light ray 3905.

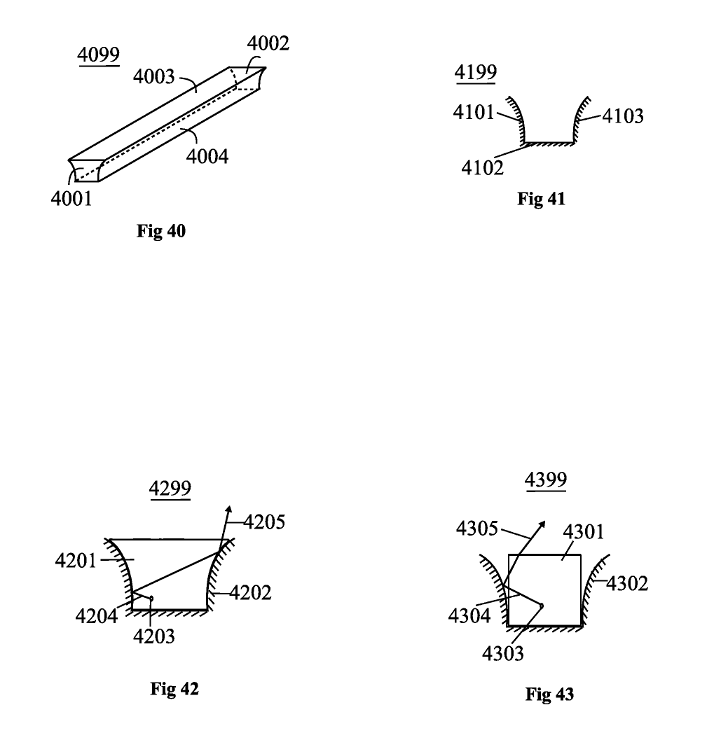

FIG. 40 illustrates a block diagram of an exemplary linear light guide 4099, according to one embodiment. The linear light guide 4099 has a cross-section that is a trapezoid but with inwardly curved non-parallel edges. The linear light guide 4099 is oriented in such a way that the two parallel faces are towards the top and bottom. The side towards the top is bigger than the side towards the bottom. Light from a light source can enter face 4001 and travel through the linear light guide 4001 towards the face 4002. Since the linear light guide 4001 comprises light deflectors, the traveling light may encounter a light deflector and may be extracted out of faces such as face 4003 and face 4004.

FIG. 41 illustrates a block diagram of an exemplary reflector 4199, according to one embodiment. The reflector 4199 is extended in one direction and has a cross-section that is a trapezoid without a top edge and with inwardly curved non-parallel edges. The parallel edges, such as edge 4102 of the trapezoid are towards the top and bottom with the smaller edge towards the bottom and the larger edge non-existent. The non-parallel edges 4101 and 4103 are curved inwards.

FIG. 42 illustrates the side view of the path taken by an exemplary scattered light ray 4204 within an exemplary linear light source 4299, according to an embodiment. A linear light guide 4201 has a cross-section that is a trapezoid but with inwardly curved non-parallel edges. The linear light guide 4201 is oriented in such a way that the two parallel faces are towards the top and bottom. The side towards the top is bigger than the side towards the bottom. The linear light guide 4201 is placed within a reflector 4202 that closely fits the sides and the bottom of the linear light guide 4201. An exemplary light ray 4204 is generated due to deflection from a light deflector 4203. The light ray 4204 reflects off the reflector 4202 multiple times before exiting as light ray 4205. The inwardly curving reflector 4202 changes the direction of deflected light so that a large amount of light will not internally reflect at the top face of the light guide 4201.

FIG. 43 illustrates the side view of the path taken by an exemplary scattered light ray 4304 within an exemplary linear light source 4399, according to an embodiment. A linear light guide 4301 has a prism shape with a square or rectangular cross-section. The linear light guide 4301 is placed within a three-sided reflector 4302 that has inwardly curved sides. An exemplary light ray 4304 is generated due to deflection from a light deflector 4303. The light ray 4304 refracts out of the light guide, reflects off the reflector 4302, reenters the light guide and comes out as light ray 4305.

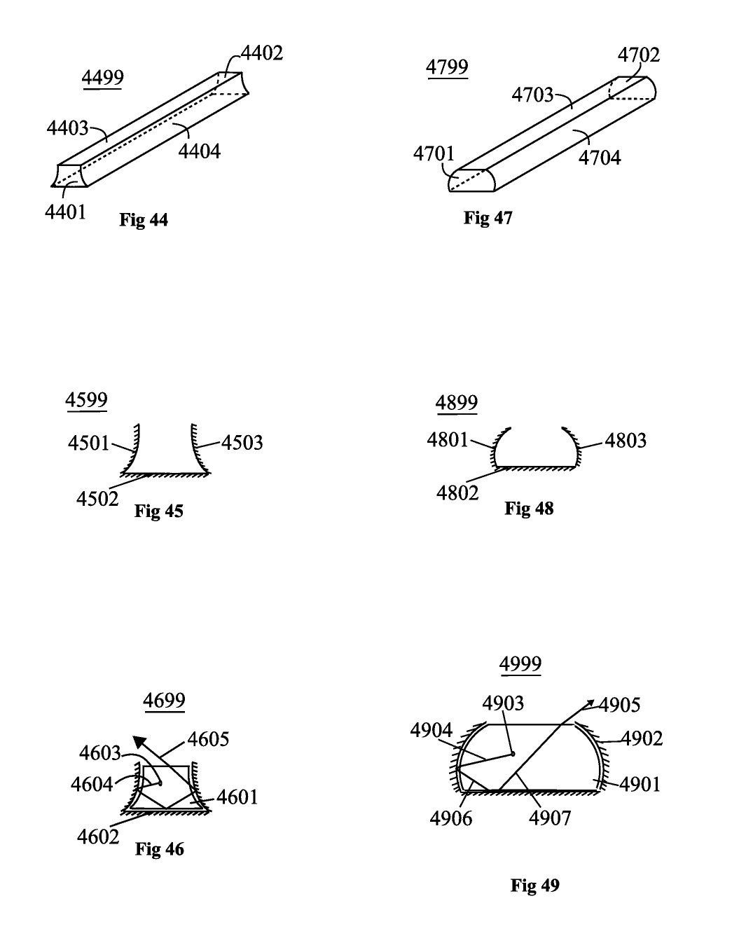

FIG. 44 illustrates a block diagram of an exemplary linear light guide 4499, according to one embodiment. The linear light guide 4499 has a cross-section that is similar to a trapezoid but with inwardly curved non-parallel edges. The linear light guide 4499 is oriented in such a way that the two parallel faces are towards the top and bottom. The side towards the top is smaller than the side towards the bottom. A smaller side at the top allows for the coupling of a thinner sheet light guide on top of the linear light guide 4499. Light from a light source can enter face 4401 and travel through the linear light guide 4499 towards the face 4402. Since the linear light guide 4499 comprises light deflectors, the traveling light may encounter a light deflector and may be extracted out of faces such as face 4403 and face 4404.

FIG. 45 illustrates a block diagram of an exemplary reflector 4599, according to one embodiment. The reflector 4599 is extended in one direction and has a cross-section that is similar to a trapezoid without a top edge and with inwardly curved non-parallel edges. The parallel edges, such as edge 4502 of the trapezoid are towards the top and bottom with the larger edge towards the bottom and the smaller edge non-existent. The non-parallel edges 4501 and 4503 are curved inwards.

FIG. 46 illustrates the side view of the path taken by an exemplary scattered light ray 4604 within an exemplary linear light source 4699, according to an embodiment. A linear light guide 4601 has a cross-section that is a trapezoid but with inwardly curved non-parallel edges. The linear light guide 4601 is oriented in such a way that the two parallel faces are towards the top and bottom. The side towards the top is smaller than the side towards the bottom. The linear light guide 4601 is placed within a three-sided reflector 4602 that closely fits the sides and bottom of the light guide. An exemplary light ray 4604 is generated due to deflection from a light deflector 4603. The light ray 4604 undergoes multiple reflections off the reflector 4602 before coming out of the light guide as light ray 4605.

FIG. 47 illustrates a block diagram of an exemplary linear light guide 4799, according to one embodiment. The linear light guide 4799 has a cross-section that is similar to a trapezoid but with outwardly curved non-parallel edges. The linear light guide 4799 is oriented in such a way that the two parallel faces are towards the top and bottom. In an embodiment, the side towards the top is smaller than the side towards the bottom. Light from a light source can enter face 4701 and travel through the linear light guide 4799 towards the face 4702. Since the linear light guide 4799 comprises light deflectors, the traveling light may encounter a light deflector and may be extracted out of faces such as face 4703 and face 4704.

FIG. 48 illustrates a block diagram of an exemplary reflector 4899, according to one embodiment. The reflector 4899 is extended in one direction and has a cross-section that is similar to a trapezoid without a top edge and with outwardly curved non-parallel edges. The parallel edges, such as edge 4802 of the trapezoid are towards the top and bottom with the larger edge towards the bottom and the smaller edge non-existent. The non-parallel edges 4801 and 4803 are curved outwards.

FIG. 49 illustrates the side view of the path taken by an exemplary scattered light ray 4904 within an exemplary linear light source 4999, according to an embodiment. A linear light guide 4901 has a cross-section that is a trapezoid but with outwardly curved non-parallel edges. The linear light guide 4901 is oriented in such a way that the two parallel faces are towards the top and bottom. In an embodiment, the side towards the top is smaller than the side towards the bottom. The linear light guide 4901 is placed within a three-sided reflector 4902 that closely fits the sides and bottom of the light guide. An exemplary light ray 4904 is generated due to deflection from a light deflector 4903. The light ray 4904 undergoes multiple reflections due to the reflector 4902 before coming out of the light guide as light ray 4905.

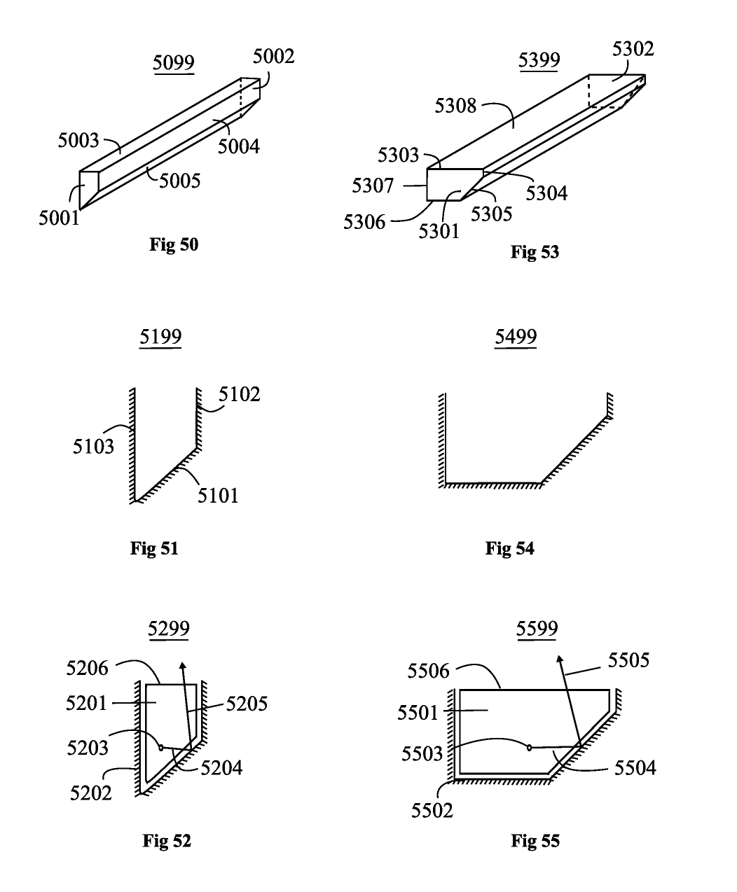

FIG. 50 illustrates a block diagram of an exemplary linear light guide 5099, according to one embodiment. The linear light guide 5099 has light deflectors embedded within the linear light guide 5099 and has two non-parallel side faces, 5003 and 5005. The other two side faces, 5004 and a side-face which is not visible in the figure are parallel to each other. The four side faces together result in a trapezoidal cross-section for the linear light guide 5099. Light from a light source can enter face 5001 and travel through the linear light guide 5099 towards the face 5002. The traveling light may encounter a light deflector and may be extracted out of the side faces such as side-faces 5003 and 5004. In an embodiment, side-face 5003 is used for coupling the extracted light into a sheet light guide and the angle formed between the side face 5005 and the side face that is not visible in the figure is 30 degrees or 45 degrees. Since the linear light guide 5099 has a trapezoidal cross-section, the coupling width (i.e. the width of the side-face 5003) is smaller.

FIG. 51 illustrates a block diagram of the cross-section of an exemplary reflector 5199, according to one embodiment. The reflector 5199 is extended in one direction and has a cross-section that is a trapezoid with one of the non-parallel edges missing. The existing non-parallel face 5101 is not perpendicular to the parallel faces 5102 and 5103 of the reflector 5199.

FIG. 52 illustrates the side view of the path taken by an exemplary scattered light ray 5204 within an exemplary linear light source 5299, according to one embodiment. The linear light source 5299 comprises a linear light guide 5201. The linear light guide 5201 has a trapezoidal cross-section with one of its non-parallel faces, face 5206 being perpendicular to its parallel faces. The linear light guide 5201 is placed within a three-sided trapezoidal reflector 5202 that properly fits around three of the faces of the linear light guide 5201. Only face 5206 is left uncovered by the reflector 5202. An exemplary light ray 5204 is generated due to deflection from a light deflector 5203. The light ray 5204 reflects off the reflector 5202 to come out of the light guide 5201 as light ray 5205.

FIG. 53 illustrates a block diagram of an exemplary linear light guide 5399, according to one embodiment. The linear light guide 5399 has light deflectors embedded within the linear light guide 5399 and has a cross-section that is a five-sided figure. The five-sided cross-section has two horizontal edges 5303 and 5306 of different lengths, such that the longer edge 5303 is towards the top. The cross-section also has two vertical edges 5304 and 5307 of different lengths such that the longer of the two 5307, connects the two horizontal edges (forming two corners) and the shorter 5304, forms a corner with the other remaining end of the longer horizontal edge 5303. The two remaining ends, one each from the shorter horizontal edge 5306 and from the shorter vertical edge 5304 are joined together using the fifth slant edge 5305. This five sided figure is also describable as a rectangle with one corner cut off. Light from a light source can enter face 5301 and travel through the linear light guide 5399 towards the face 5302. The traveling light may encounter a light deflector and may be extracted out of the side faces such as side-face 5308.

FIG. 54 illustrates a block diagram of the cross-section of an exemplary reflector 5499, according to one embodiment. The reflector 5499 has a four-sided cross-section that is similar to the cross-section of the linear light guide 5399 as shown in FIG. 53, except for the fact that the longer horizontal edge (top edge) which is towards the principle direction of light extraction is missing.

FIG. 55 illustrates the side view of the path taken by an exemplary scattered light ray 5504 within an exemplary linear light source 5599, according to one embodiment. The linear light source 5599 comprises a linear light guide 5501. The linear light guide 5501 has a cross-section like the one described for the linear light guide 5399 in FIG. 53. The linear light guide 5501 is placed within a reflector 5502 that properly fits around four of the faces of the linear light guide 5501. Only face 5506 is left uncovered by the reflector 5502. An exemplary light ray 5504 is generated due to deflection from a light deflector 5503. The light ray 5504 reflects off the reflector 5502 to come out of the light guide 5501 as light ray 5505.

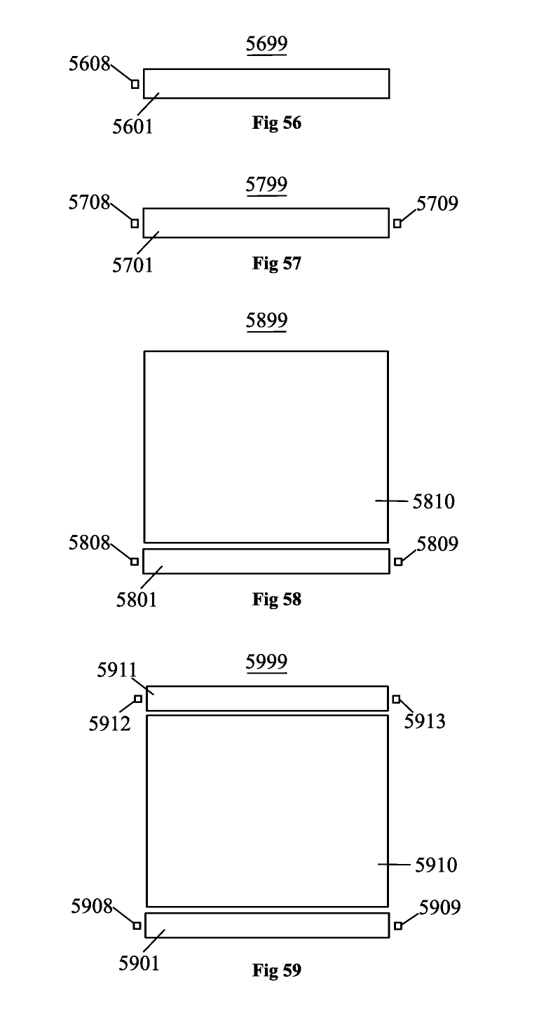

FIG. 56 illustrates a linear light source 5699, according to one embodiment. A point light source 5608 emits light into one end of a linear light guide 5601. The linear light guide 5601 has light deflectors included in it, which deflect the light being guided through it. Some of the deflected light emanates out of the linear light guide 5601 as illumination light. In an embodiment, the end of the linear light guide 5601 opposite to the point light source 5608 has a reflector disposed on or near it, so that light which reaches this end is reflected back into the linear light guide 5601 and not wasted.

In an embodiment, the light deflector is made of light scattering particles, and the particles are included in the linear light guide 5601 in such a concentration that linear light guide 5601 is transparent when viewed from outside from one of its large faces. In this case, linear light source 5699 is a light source which is transparent to external light.

In an embodiment, the linear light source is a prism whose cross section has a particular shape. The larger the area of the cross section of the prism, the larger the size of the point light source and hence the power of the point light source which can source light into the linear light source. Also, the larger the area of the cross section of the prism, the larger the size of a reflector that can be used next to point light source to reflect back light exiting the linear light guide. The smaller the horizontal spread of the cross section of the prism, the thinner the sheet light guide that light can be coupled into. Besides aesthetic, cost and environmental reasons, using thinner sheet light guides can also make them more transparent to light entering from outside. The sheet light guide can be made thinner than the horizontal spread of the cross section of the prism by use of a reflector whose top exit aperture is smaller than the horizontal spread. Using non parallel side walls in the prism is also beneficial, since it reduces the total number of reflections of light within the reflector cavity. Thus, more area of cross section, smaller horizontal spread and non-parallel side walls enhance the extraction of light from a linear light guide.

FIG. 57 illustrates a linear light source 5799, according to one embodiment. Point light sources 5708 and 5709 emit light into both the ends of a linear light guide 5701. The linear light guide 5701 has light deflectors included in it.

FIG. 58 illustrates a surface light source 5899, according to one embodiment. A linear light source 5801 emits light into one edge of a sheet light guide 5810. The sheet light guide 5810 has light deflectors included in it, which deflect the light being guided through it. Some of the deflected light emanates out of the sheet light guide 5810 as illumination light. In an embodiment, the edge of the sheet light guide 5810 opposite to the linear light source 5801 has a reflector disposed on or near it, so that light which reaches this edge is reflected back into the sheet light guide 5810 and not wasted. In an embodiment, the edges that meet the edge near the linear light source 5801 have reflectors disposed on or near them.

In an embodiment, the light deflector is made of light scattering particles, and the particles are included in the sheet light guide 5810 in such a concentration that sheet light 5810 is transparent when viewed from outside from one of its large faces. In this case, the surface light source 5899 is a light source which is transparent to external light.

The light deflector, or the optional mirror at the other end, may send light traveling in the sheet light guide 5810 back towards the linear light source 5801. A transparent linear light source is beneficial, since a large part of this light will then reflect off the reflectors of linear light source 5801 and reenter the sheet light guide 5810.

FIG. 59 illustrates a surface light source 5999, according to one embodiment. Linear light sources 5901 and 5911 emit light into two opposite edges of a sheet light guide 5910. The sheet light guide 5910 has light deflectors included in it.

The light deflector or the linear light source at the other end may send light traveling into a linear light source. A transparent linear light source is beneficial in this case.

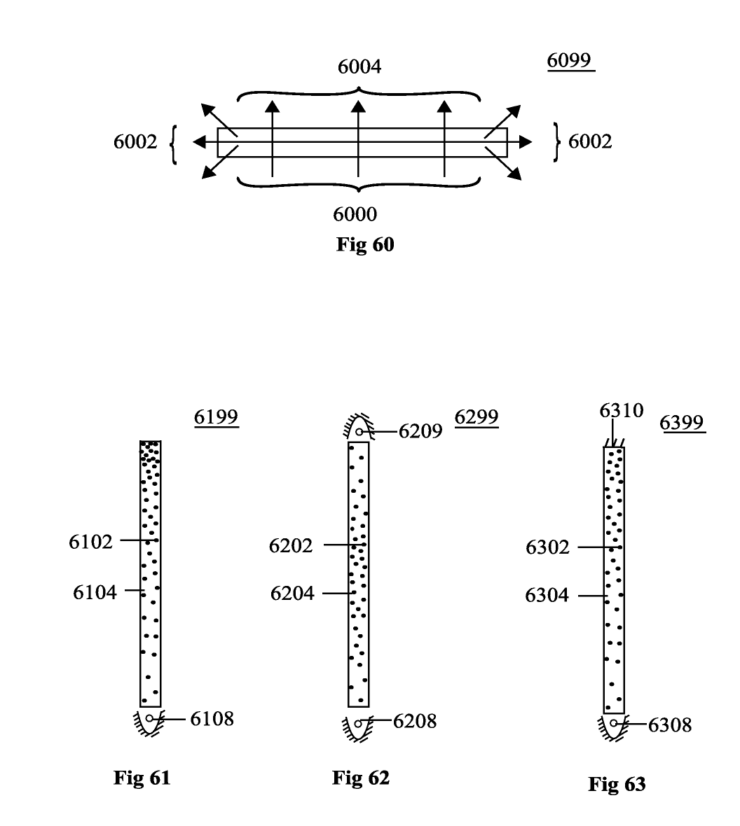

FIG. 60 illustrates an exemplary element 6099 of a light guide having light deflector, according to one embodiment. Element 6099 is a small sliver of the light guide at a particular distance from the end of the light guide that is near a light source. It has a very small height (but the other dimensions of the light guide). The light guide of which element 6099 is an element, may be a linear or surface light guide, forming, correspondingly, a linear or surface light source.

Light 6000, emanated by a light source, and guided by the light guide portion before the element 6099, enters element 6099. Some of the light gets dispersed due to light deflector included in the light guide, and leaves the light guide as illumination light 6002. The remaining light continues on to the next element as light 6004. The power of entering light 6000 is matched by the sum of the powers of illumination light 6002 and continuing light 6004. The fraction of dispersed illumination light 6002 with respect to entering light 6000 is the photic dispersivity of element 6099. The ratio of the photic dispersivity of element 6099 to the height of element 6099 is the photic dispersion density of element 6099. As the height of element 6099 decreases, the photic dispersion density (of this element) approaches a constant. This photic dispersion density of element 6099 bears a certain relationship to the concentration of light deflecting particles in the element 6099. The relationship is approximated to a certain degree as a direct proportion. By knowing the concentration of light deflecting particles of element 6099, the photic dispersion density of element 6099 may be evaluated, and vice versa.

As the height of element 6099 is reduced, power in the illumination light 6002 reduces proportionately. The ratio of power of illumination light 6002 to the height of element 6099, which approaches a constant as the height of the element is reduced, is the emanated power density at element 6099. The emanated power density at element 6099 is the photic dispersion density times the power of entering light 6000. The gradient of the power of light traveling through the element 6099 is the negative of the emanated power density. These two relations give a differential equation:

dP/dh=−qP=−K

where
h is the distance of the element from the light source end of the light guide,
P is the power of the light being guided through element,
q is the photic dispersion density of element and
K is the emanated power density at element.

This differential equation applies to all elements of the dispersing light guide. It is used to find the emanated power density given the photic dispersion density at each element. This equation is also used to find the photic dispersion density of each element, given the emanated power density. To design a light source with a particular emanated power density pattern (emanated power density as a function of distance from the light source end of the light guide), the above differential equation is solved to determine the photic dispersion density at each element of the light guide. From this, the concentration of light deflecting particles at each element of a light guide is determined.

If a uniform particle concentration is used in the light guide, the emanated power density drops exponentially with distance from the end. Uniform emanated power density may be approximated by choosing a particle concentration such that the power drop from the end near the light source to the opposite end, is minimized. To reduce the power loss and also improve the uniformity of the emanated power, the opposite end reflects light back into the light guide. In an alternate embodiment, another light source provides light into the opposite end.

FIG. 61 illustrates an exemplary light source 6199 having a varied concentration of light deflecting particles, according to one embodiment. The concentration of light deflecting particles 6102 is varied from sparse to dense from the light source end (near light source 6108) of light guide 6104 to the opposite end.

To achieve uniform illumination, the photic dispersion density and hence the particle concentration has to be varied over the light guide. The photic dispersion density is varied according to

q=K/(A−hK)

where

A is the power going into the light guide 6104 and

K is the emanated power density at each element, a constant number (independent of h) for uniform illumination.

If the total height of the light guide 6104 is H, then H times K should be less than A, i.e. total power emanated should be less than total power going into the light guide, in which case the above solution is feasible. If the complete power going into the light guide is utilized for illumination, then H times K equals A. In an embodiment, H times K is kept only slightly less than A, so that only a little power is wasted, as well as photic dispersion density is always finite.

FIG. 62 illustrates an exemplary light source 6299 having two light sources, according to one embodiment. By using two light sources 6208, 6209, high variations in concentration of light deflecting particles 6202 in the light guide 6204 is not necessary. The differential equation provided above is used independently for deriving the emanated power density due to each of the light sources 6208, 6209. The addition of these two power densities provides the total light power density emanated at a particular light guide element.

Uniform illumination for light source 6299 is achieved by varying photic dispersion density according to

q=1/sqrt((h−H/2)̂2+C/K̂2)

where

sqrt is the square root function,

̂ stands for exponentiation, and

C=A (A−HK).

FIG. 63 illustrates an exemplary light source 6399 having a mirrored light guide, according to one embodiment. By using a mirrored light guide 6304, high variations in concentration of light deflecting particles 6302 is not necessary. Top end 6310 of the light guide 6304 is mirrored, such that it reflects light back into the light guide 6304.

Uniform illumination for light source 6399 is achieved by varying photic dispersion density according to

q=1/sqrt((h−H)̂2+D/K̂2)

where D=4A (A−HK).

Linear light source shapes that enhance light extraction are disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

We claim:

1. An apparatus comprising:
A light source,
a light guide placed adjacent to the light source, the light guide including a plurality of light deflectors,
a reflector placed adjacent to the light guide, wherein
the reflector prevents light emanation from the light guide in some directions

2. The apparatus of claim 1 wherein the reflector has at least one pair of non-parallel walls.

3. The apparatus of claim 1 wherein the light guide has at least one pair of non-parallel walls.

4. The apparatus of claim 3 wherein the light guide is a triangular prism.

5. The apparatus of claim 3 wherein the light guide is a prism with a trapezoidal cross-section.

6. The apparatus of claim 3 wherein the light guide is a prism with a pentagonal cross-section.

7. The apparatus of claim 3 wherein the light guide is a prism with a parallelogram cross-section.

8. The apparatus of claim 3 wherein the light guide is a prism with a rhombus cross-section.

9. The apparatus of claim 3 wherein the light guide is a prism with a cross-section that is a curvilinear quadrilateral.
